(19) United States
(12) Patent Application Publication
(10) Pub. No.: US 2006/0179012 A1
(43) Pub. Date: Aug. 10, 2006

(54) Computer program for preparing contractor estimates

(76) Inventor: Robert Jacobs, Ferndale, MI (US)

Correspondence Address: HARNESS, DICKEY & PIERCE, P.L.C., P.O. BOX 828, BLOOMFIELD HILLS, MI, 48303, US

(21) Appl. No.: 11/348,790

(22) Filed: Feb. 7, 2006

Related U.S. Application Data
(60) Provisional application No. 60/651,404, filed on Feb. 9, 2005.

(51) Int. Cl. G06F 17/00

(52) U.S. Cl. 705/400

(57) ABSTRACT

A computer program for estimating underground piping systems operates as a condensed spreadsheet having predetermined user-defined default values. A rough cost estimate is produced by the user making an original selection and then entering as few as two data columns, an item name and an item quantity. A single six-page report is generated having the first two pages displaying costs, the following three pages displaying backup data and the sixth page providing user comments. Eight items common to the field are categorized and appear in data sheets. Estimation formulas are substituted for large data tables. The program stores data input and/or updated by the user, interpolates or extrapolates for items not provided with specific criteria and provides user designated rounding factors and tax factors for calculating costs.

### CROSS-REFERENCE TO RELATED APPLICATIONS

This application claims the benefit of U.S. Provisional Application No. 60/651,404 filed on Feb. 9, 2005. The disclosure of the above application is incorporated herein by reference.

### FIELD

The present disclosure relates in general to computer cost estimation programs and more specifically to a computer program for preparing excavation and piping system construction cost estimates.

### BACKGROUND

Estimators currently use computer programs to prepare project estimates in a variety of fields. In the construction industry, computer programs can be purchased for use by contractors and/or estimators in calculating construction project costs including costs for example for excavation and piping systems. These programs commonly provide a database which is large and therefore frequently updated by the program owner. Some programs include database information having costs from an entire country or region which are averaged. A factor is then applied to correct for different sections of the country for more accurately determining local, and current component and material costs. Maintaining such a database is a continuous process and is costly and therefore its use can result in continuing costs to the user of the program. Also, the estimator's local knowledge of costs and item use to meet code requirements is often not advantageously accommodated by the program.

The acquisition of updated information commonly requires payment of a user fee for access or downloading, and often requires the program user to access the owner's database. Common programs of this type have multiple screens and windows which are accessed for each component type and for each stage of the estimate, from which the user determines size, length, weight, volume, etc. for each component or item of a system being estimated.

Because of the size and complexity of the database, a step-by-step, one-time-through format is often required which can require significant training by the user and can result in detailed estimates that often cannot be reviewed for accuracy without printing multiple reports. Correction or modification of the estimate then requires a similar step-by-step process using many windows and screens and a similarly large number of printed reports. The user also may not have visible access to a changing estimate total and is not shown the impact individual changes are making on the estimate until the end of the process when the reports are printed.

### SUMMARY

According to several embodiments of the present disclosure, a computer program for preparing contractor estimates operates as a spreadsheet enabled using a program such as Microsoft™ Excel. The program includes a plurality of data sheets each having a plurality of data cells. A group of work items is displayable in predetermined ones of the plurality of the data cells and selectable by the user for management of a plurality of work items. At least one user inputted work item cost is expandable by the program using a regression analysis into a plurality of work item costs. An estimated project cost is created when the user inputs a minimum of a work item name and size, and work item quantity.

According to other aspects of the present disclosure, the computer program recognizes work items and their sizes as they are entered in a data sheet. The program retrieves associated cost data of matching work items stored in a program data sheet. This retrieved data combined with user provided default data in the worksheet produces an estimated project cost.

According to yet another aspect of the disclosure, the computer program database sheet includes work item names and associated combinations of hard number data and formulas, which can be converted to hard numbered data. This formula stored data condenses the database, but can be easily viewed, entered, modified or deleted by a user.

According to yet still another aspect of the disclosure, pop-up windows appear when the user selects predetermined cells of the spreadsheet data sheets. The pop-up windows allow data entry/modification, provide explanations of how data is used or input or of the terms used, viewing of data, and/or viewing of formulas used to generate the data appearing in the cell(s). Formulas applied to limited data entered by the user in predetermined pop-up windows can either extrapolate or interpolate the limited data to identify a broad range of similar item data, such as multiple size ranges and/or estimated costs.

In still another aspect of the present disclosure, the user can input one or more aliases for any work item named in the database. The program thereafter recognizes the original work item name and any alias(es) uniquely assigned to the original work item name. Aliases can also be abbreviations of work item names, or full descriptions of the work items.

In yet another aspect of the present disclosure, one or both of a plurality of rounding factors and tax factors are assigned by the user when preparing cost estimates. These factors are selected for application and defined at predetermined data field boxes or cells of the spreadsheet data sheets.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flow diagram identifying 5 data sheets and a process flow path for a computer program for estimating construction including piping systems according to the present disclosure;

FIG. 2 is a plan view of a total costs section of a worksheet of the present disclosure as displayable on a computer monitor;

FIG. 3 is a plan view of a unit costs section of the worksheet;

FIG. 4 is a plan view of a labor and equipment costs section of the worksheet;

FIG. 5 is a plan view of a volume calculation section of the worksheet;

FIG. 6 is a plan view of a pipe/material/subcontracts section of the worksheet;

FIG. 7 is a plan view of a duration and remarks section of the worksheet;

FIG. 8 is a plan view of a total costs section printout;

FIG. 9 is a plan view of an exemplary row insertion format;

FIG. 10 is a plan view of the volume calculation section of the worksheet showing additional excavation, fill, and trench bedding data;

FIG. 11 is a plan view of another view of the volume calculation section of the worksheet showing alternate trench bedding data;

FIG. 12 is a plan view of a pipe/material/subcontracts section showing additional bedding data;

FIG. 13 is a plan view of a unit-prices sheet;

FIG. 14 is a plan view of a unit price print out;

FIG. 15 is a plan view of a database sheet;

FIG. 16 is a plan view of an exemplary database pop-up work item with various sizes;

FIG. 17 is a plan view of an exemplary data base pop-up for items lacking various sizes;

FIG. 18 is a plan view of a database table of aliases;

FIG. 19 is a plan view of a database price history table;

FIG. 20 is a plan view a conversion table sheet;

FIG. 21 is a plan view of the total costs section of the worksheet of FIG. 2 further showing a work item pop-up window; and

FIG. 22 is a diagrammatic view of an exemplary application of the estimating program of the present disclosure.

### DETAILED DESCRIPTION

The following description of the preferred embodiments is merely exemplary in nature and is in no way intended to limit the disclosure, its application, or uses.

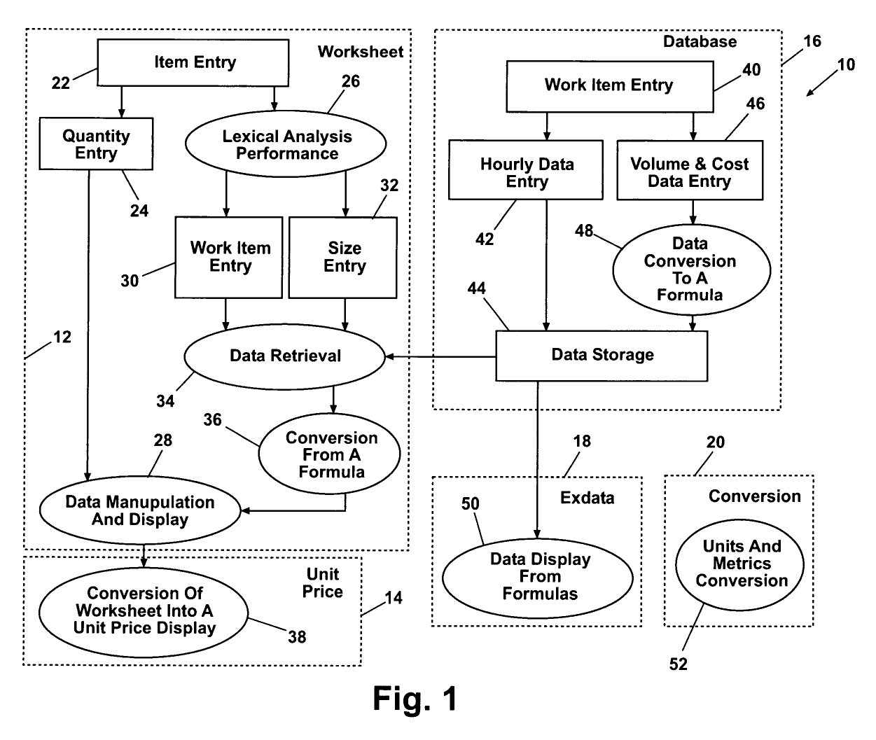

According to a preferred embodiment for a computer program to prepare construction estimates for construction and piping systems of the present disclosure, and referring generally to FIG. 1, an estimating program 10 includes a plurality of sheets, including a worksheet 12 and a database sheet 14 each having user entry capability and program function items. Database sheet 14 presents data stored in a database of estimating program 10 (a portion of the database is viewable as database sheet 14). Estimating program 10 further includes a unit price sheet 16, a price list sheet 18, and a conversion sheet 20. The term “sheet” or “data sheet” as used herein refers to various spreadsheets within the program. The term “section” refers to that range of contiguous columns within a spreadsheet that can be viewed on a single screen. For view screens or monitors of appropriate size, the columns viewed on the view screen or monitor generally correspond to columns displayed on a printed page. The sheets are divisible into two groups including a first group operable as read-only data cells (including price list sheet 18) and a second group (including worksheet 12) having user operable data for entering or modifying data.

The individual sheets 12, 14, 16, 18 and 20 identify user entered information in rectangular boxes and a plurality of program functions identified in oval shaped windows. Worksheet 12 provides for multiple entries of a work item/size 22. For each work item/size 22, a parsing function 24 recognizes and parses or separates an individual work item 26 such as an ASCII formatted character from a work item size 28, thus providing the information required to retrieve data from database sheet 14. For each work item/size 22, the user also enters a quantity 30. Following performance of the parsing function 24 to separate work items 26 from sizes 28, estimating program 10 performs a data retrieval function 32. Data retrieval function 32 extracts data from the database. To reduce the volume of data which is used or saved within estimating program 10, instead of providing values for every conceivable size, quantity and/or type of item, estimating program 10 includes a plurality of formulas. The formulas are derived through either an interpolation function or using regression analysis when extrapolation of data is required using a limited set of data entries in a formula conversion function 34 to convert the data entries into multiple data entries. The formulas are provided in a language such as Visual Basic or Visual Basic Application, but the program is not limited to a specific language. Following formula conversion function 34 and/or entry of quantity 30, the data is manipulated and final cost displayed by a data manipulation and display function 36.

Database sheet 14 provides a user work item entry 40. A user provided hourly data entry 42 follows work item entry 40 and precedes storage of the data in a data storage function 44. In parallel with hourly data entry 42, the user is also provided with a volume and cost data entry 46. Following entry of the data via volume and cost data entry 46, estimating program 10 includes a data-to-formula conversion function 48. Data-to-formula conversion function 48 incorporates volume and cost data into one or more formulas. This information is then stored during data storage function 44.

Unit price sheet 16 provides for a lump-sum-to-unit-price conversion function 38. This function allows the user the option to view any of the individual work items 26 of worksheet 12 with a percent mark-up added to each of their unit costs and make modifications as desired. Costs adjustments cannot be made on unit price sheet 16 on the items in columns “G” through “O” and are available for viewing only.

Estimating program 10 in price list sheet 18 allows the user to extract and display data on the database sheet 14 using data storage function 44 as display values following re-conversion of the data from the various formulas. This feature is permitted by a data display function 50.

Conversion sheet 20 provides the user with the capability of adding or revising the various units and conversion factors used in estimating program 10 and viewing the individual conversion tables and data of the conversion tables provided in a units/metrics conversion function 52. This provides the user with the added ability of operating estimating program 10 in a plurality of countries having different engineering units for describing input data, for example, U.S. or metric forms. Also displayed and capable of being revised are tax factors for various materials, as well as an over-time factor. Data can also be entered in one unit format and converted for viewing into another unit format.

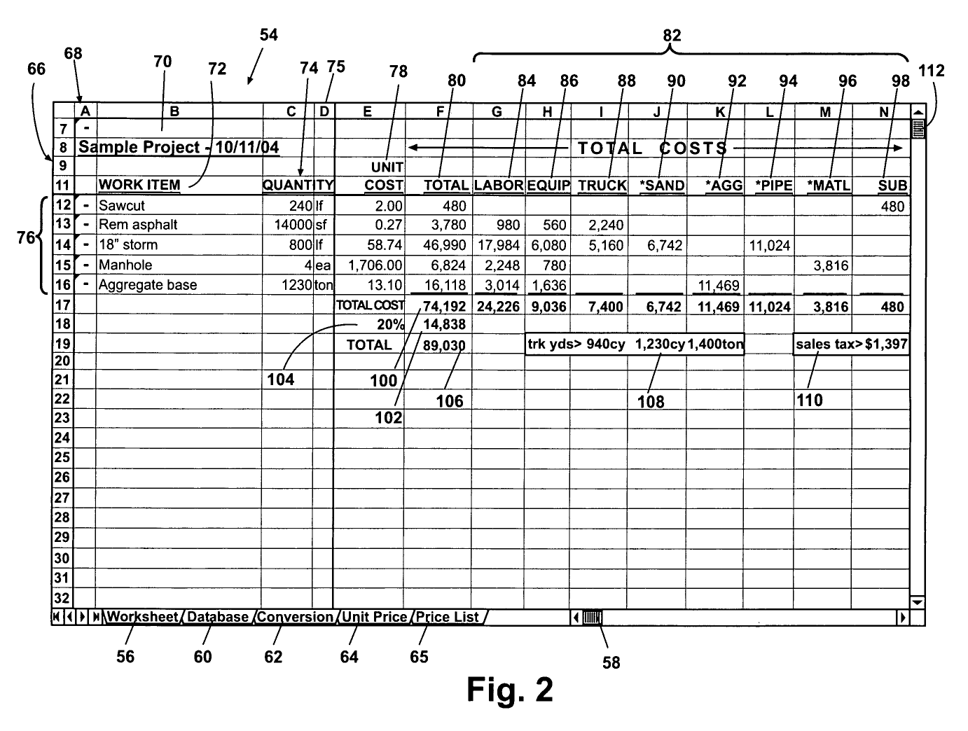

Referring next to FIG. 2, a total costs section 54 of worksheet 12 is shown. Because estimating program 10 functions as a template used for example with the Microsoft™ Excel program, individual data sheets are displayed having rows and columns formatted similar to the Excel program. Total costs section 54 and other sections are selected by the user by selecting a worksheet tab 56 and scrolling a selector bar 58 to the desired section. Additional sheets are available by clicking on their respective tab, including a database tab 60, a conversion tab 62, a unit price tab 64 or a price list tab 65. In the example of FIG. 2, total costs section 54 is used by selecting worksheet tab 56 and entering a plurality of data.

Each sheet or section including total costs section 54 is provided with row designators 66 having a plurality of numerically identified rows, and column designators 68 distinguishing a plurality of alphabetically configured columns. The user initiates data entry into total costs section 54 by first entering a job title into a job title bar 70 (which can optionally include a date to help distinguish individual jobs), at least one work item entry 26 in a work item column 72 (item 22 on FIG. 1 is a combination of work item 26 and size 28), and at least one quantity 30 (associated with the work item 26) in a quantity column 74. Estimating program 10, using the data input in job title bar 70, work item column 72 and quantity column 74 determines an associated unit of measure 75, calculates total costs associated with each of a predetermined group of work items 76, and a predetermined unit cost 78 resulting in a total cost 80, and includes individual costs for each of a plurality of field-specific items 82.

Total costs section 54 contains columns labeled A through N of column designators 68 and can also be referred to as the ‘total costs’ section or page of worksheet 12. Column A is blank except for a dash visually indicating that the row is formatted, and can be overwritten with an optional item number. Column B provides for manual input of the work item(s) 26 in rows numbered 12 and higher. Column C provides a numerical entry for a quantity 74 associated with each work item 76. Column D provides for manual input of unit of measures 75 for each work item 76. However, if the work item entered in column C is recognized as an item currently in database sheet 14, data need not be manually entered in column D or any other column to the right, as pertinent data will have already been automatically entered by estimating program 10 and other computations and relevant data generated.

Data cannot be manually entered in columns E through N. Column E provides a total unit cost for each work item 76 which estimating program 10 copies from total unit cost column O on a subsequent section of worksheet 12. Column F is a sum of each of the values in columns G through N for each work item 76. Columns G through N provide a total cost for each of an exemplary quantity of eight field-specific items 82 which include a labor costs 84, an equipment costs 86, a trucking costs 88, a sand costs 90, an aggregate costs 92, a pipe costs 94, a material costs 96, and a subcontracts costs 98 for each work item 76. An asterisk associated with a title such as ‘sand’ indicates an item which is taxable and alerts the user that tax data also applies to values identified.

Each of the items of field-specific items 82 are preselected and stored in estimating program 10 and are specifically applicable to preparation of excavation and/or utility contractor estimates for a construction project. By selecting a predetermined macro-key, all the data in rows 17-19 and columns E-N automatically appear. A subtotal job cost 100 is calculated based on the total cost 80 for each of the work items 76. A mark-up value 102 is added to the subtotal job cost 100 based on a percentage 104 identified by the user. The sum of the subtotal job cost 100 plus the mark-up value 102 is provided as a job total estimated price 106. Total costs section 54 also provides the user with the capability of identifying special information using a special information window 108 identifying total cubic yards of excavation, total cubic yards of sand and total tons of aggregate, and a total sales tax window 110. A vertical scroll bar 112 allows the user to scroll up or down between multiple work items if the number of work items exceeds the 31 rows of work items shown.

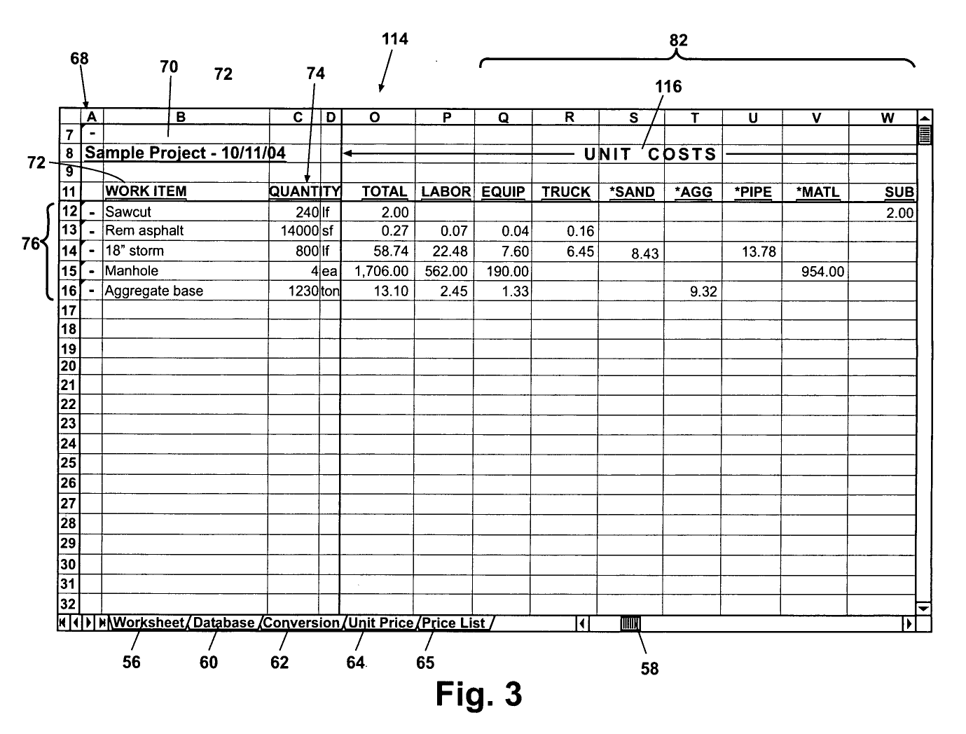

Referring next to FIG. 3, a unit costs section 114 includes a unit costs summary section 116 which appears by scrolling selector bar 58 as viewed in FIG. 3. Unit costs section 114 includes column designators 68 ranging from A through D in common with total costs section 54. By scrolling selector bar 58 further to the right from total costs section 54, the user is able to view unit costs section 114 of worksheet 12 which includes, in addition to columns A through D, column designators 68 ranging from the letter O through W. For consistency, unit costs section 114 identifies job title bar 70, work item column 72, quantity column 74 and each of the plurality of work items 76. In addition, unit costs section 114 identifies the individual or unit cost for each of the field-specific items 82 identified in FIG. 2. Unit costs section 114 is used to identify the current information available in estimating program 10 for the individual unit costs of each of the work items 76. Column O is a sum of each of the values in columns P through W for each work item 76. Columns P through W provide a unit cost of the work item for each of: labor, equipment, trucking, sand, aggregate, pipe, material, and subcontractor unit cost, respectively.

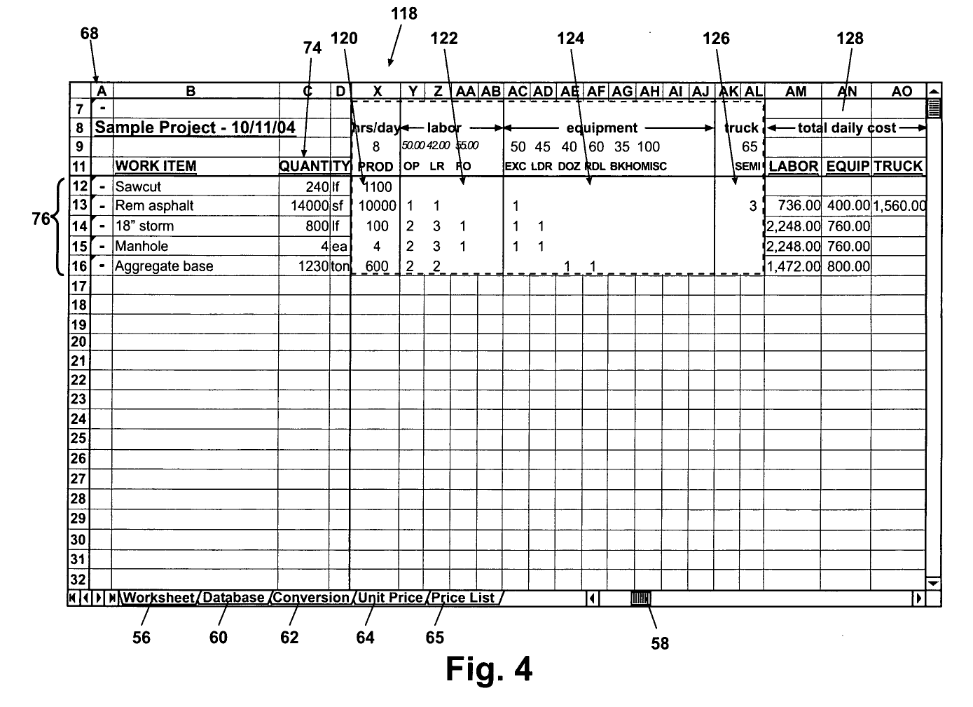

Referring now to FIG. 4, a labor/equipment section 118 includes the same left-hand side information as provided in total costs section 54, including columns A through D of column designators 68, and each of the plurality of work items 76. New information provided by labor/equipment section 118 is viewed by scrolling selector bar 58 as viewed in FIG. 4 until labor/equipment section 118 having for column designators 68 the letters X through AO appears. Data of labor/equipment section 118 includes a production-per-day column 120 in column X, a laborers-used-per-day section 122 broken down into labor types in columns Y through AB, an equipment-quantity-per-day section 124 broken down into equipment types in columns AC through AJ, a truck quantity per day section 126 broken down into truck types in columns AK through AL, and a daily-total-costs section 128 broken down into labor, equipment and trucking total costs in columns AM through AO.

Production-per-day section 120 provides estimated number of units of a particular work item in the total quantity column 74 that can be completed in one day for each of the work items 76. A quantity of hours used to identify work hours per day is a default number that can be selected by the user. In the example shown the quantity of hours has been selected as eight hours per day. This quantity can be changed by the user to accommodate shorter or longer working days. In the laborers-used-per-day section 122, data automatically retrieved from the database provides the number of laborers required and a labor rate to perform the daily amount of work against each of the work items 76. This can include, for example, operators (OP), laborers (LR) and foremen (FO), etc. Additional types of crew members can also be identified by the user. Equipment-quantity-per-day section 124 identifies the number of equipment types used per day and an hourly rate for each type, for example excavators (EXC), loaders (LDR), dozers (DOZ), etc.

The truck quantity per day section 126 identifies the number of truck types used per day and an hourly rate, for example, semis (SEMI), trains, etc. Using the information input into each of sections 120 through 126, estimating program 10 calculates and displays in daily total costs section 128 a total cost for each of the work items 76 divisible into each of the categories of labor, equipment and trucking. For example in FIG. 4, for work item 13, asphalt removal, an 8 hour day is selected in column X, one operator at $50/hr, one laborer at $42/hr, one excavator at $50/hr and 3 semi trucks at $65/hr are identified. The subtotal for each of the labor, equipment and trucking are identified in total daily costs columns AM, AN and AO respectively.

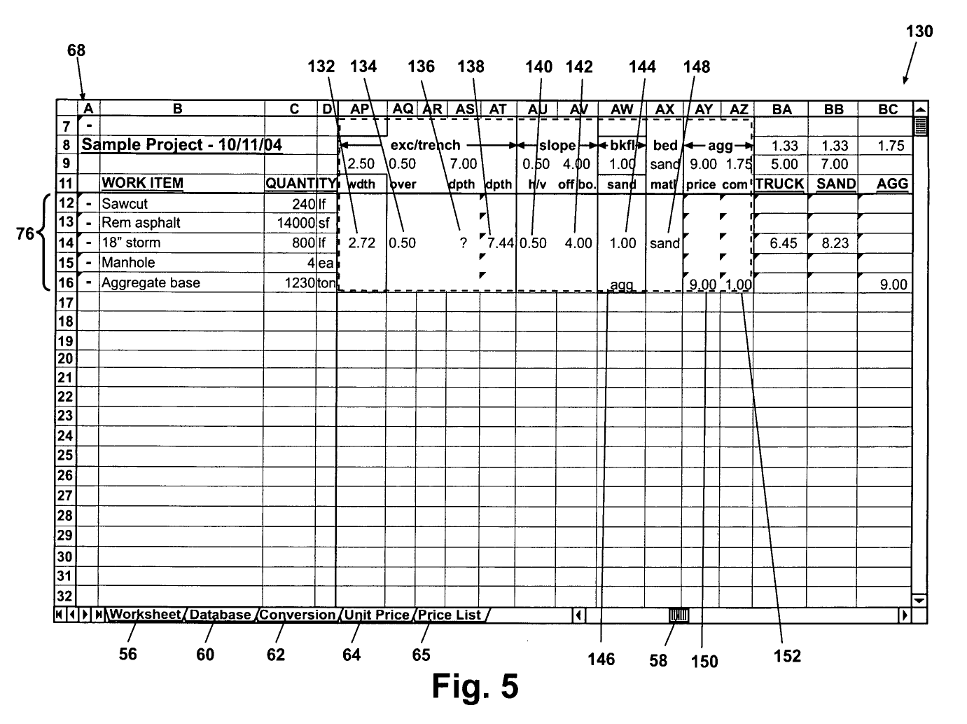

As best seen in reference to FIG. 5, a volume calculation section 130 of worksheet 12 includes the same left hand information as total costs section 54. Volume calculation section 130 is accessed by further scrolling selector bar 58 to the right as shown in FIG. 5 until volume calculation section 130 having in column designators 68, the columns AP through BC, each having values calculated as described in reference to Table 1 herein. Volume calculation section 130 is provided for the user to add or modify information related to trucking, sand and aggregate associated with each of the work items 76. Trench volume calculations based on the above values are automatically performed by estimating program 10 and displayed to the right in volume calculation section 130. Volume calculation section 130 further includes a trench width value 132, an oversize space value 134, a depth value 136, a depth value 138, a trench wall slope value 140, a start-of-slope distance 142, a portion of trench backfilled with sand value 144, a unit and type of fill for a non-trench work item aggregate 146, a bedding type 148, an aggregate price 150, and an aggregate conversion factor 152 for each of the work items 76.

Exemplary data is shown in volume calculation section 130 for an 18 inch storm pipe work item. Oversize space value 134 represents the oversize spacing between a pipe and the associated trench wall having a unit of measure in feet. Depth value 136 is a depth in feet to the pipe invert. Depth value 138 represents a total depth of the trench measured to the bottom of the trench. Trench wall slope value 140 represents a rise over run value representing the slope or pitch of the trench wall. Start-of-slope distance 142 represents a distance from the bottom of the trench to a start of the sloping portion of the trench. The portion of trench backfilled with sand value 144 represents that portion of the trench which includes sand backfill. The aggregate (agg) 146 is exemplary of an alternate function of column AW, identifying the type of fill material, for example aggregate (agg) or sand material used with a non-trench work item, instead of that portion of sand backfill as it typically applies with a trench related work item. Bedding type 148 represents the material used for the trench bedding, in this example sand. Aggregate price 150 is a per ton price. Conversion factor 152 allows the user to compensate for truck load quantities of the aggregate which can affect the cost estimate depending upon the volume of the material capable of being hauled. Different aggregates have different load quantities based on their weight per unit volume and therefore the volume that can be hauled per truckload. Columns BA, BB and BC are calculated as described in reference to Table 1 herein.

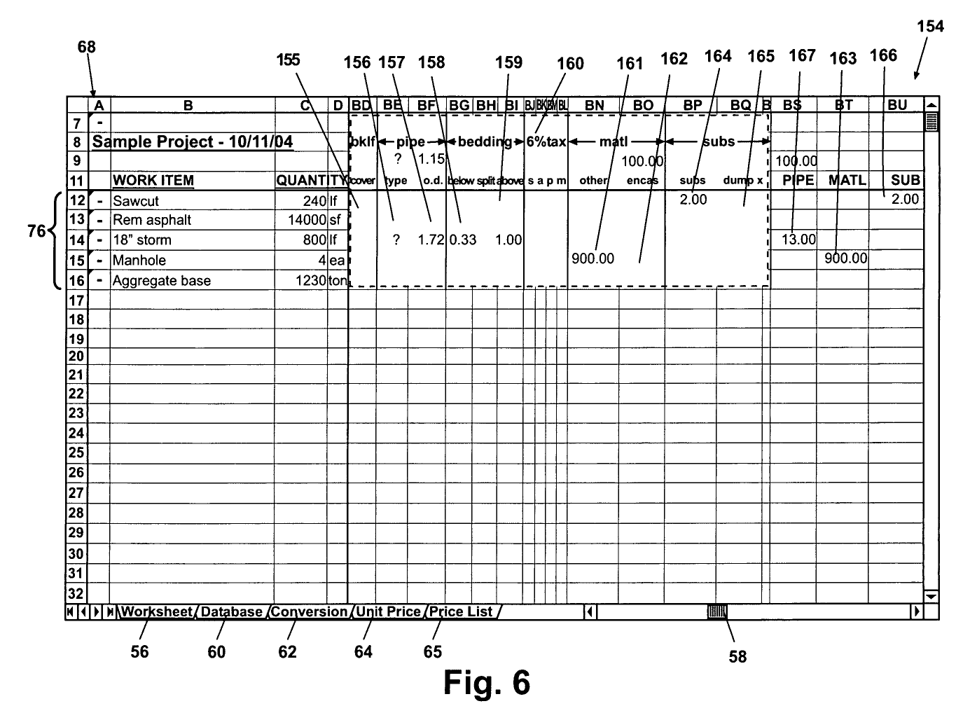

As shown in FIG. 6, a pipe/material/subcontracts section 154 provides left hand information common to each of the previously identified sections and similar to total costs section 54. Pipe/material/subcontracts section 154 is viewed by further scrolling selector bar 58 to the right as shown in FIG. 6 from the view of volume calculation section 130 previously described until pipe/material/subcontracts section 154 having column designator letters BD through BU is visible. Pipe/material/subcontracts section 154 includes a trench-top-to-backfill distance 155 in column BD, a pipe type 156 in column BE, a pipe outside diameter 157 in column BF, a bedding-thickness-below-pipe 158 in column BG, a bedding-thickness-above-pipe 159 in column BI, and a tax 160 associated with each work item 76 in columns BJ through BL for sand(s), aggregate(a), pipe(p) and other materials(m). Pipe/material/subcontracts section 154 includes further items as follows. An ‘other’ material 161 in column BN is retrieved from the database and viewable on database sheet 14. An encasement material cost 162 in column BO is generated from volume calculations in the preceding section, which added together equal a material unit costs 163 in column BT. In similar manner, a subcontracts cost 164 in column BP contains data retrieved from the database sheet 14 and a dump fee cost 165 in column BQ are generated from volume calculations in the preceding sections, which added together equal a subcontracts unit cost 166 in column BU. A pipe costs 167 in column BS is retrieved from data directly from the data base. Data in columns BD through BU are calculated as further described in reference to Table 1 herein.

Trench-top-to-backfill distance 155 represents the cover or distance from the top of the trench to the top of the backfill. Items 156 through 159 are self-explanatory. Tax is automatically added to sand, aggregate, pipe, and materials. If for example a supplier has included tax in his price, an “X” provided by the user in the appropriate column BJ through BL avoids duplication of that tax. Tax 160 can be adjusted by the user to accommodate individual State taxes, County taxes, City taxes, etc. Calculated values for each of the work items 76 are presented to the right of pipe/material/subcontracts section 154. Data in columns BD-BR provide user adjustable source data for columns BS-BU and are calculated as further described in reference to Table 1 herein.

Referring generally to FIGS. 4, 5 & 6, areas defined by dashes contain the “source data” which defines the estimated costs generated by estimating program 10. For example, in FIG. 4, data in columns AM-AO is automatically changed by the user adding or changing a value in columns X-AL.

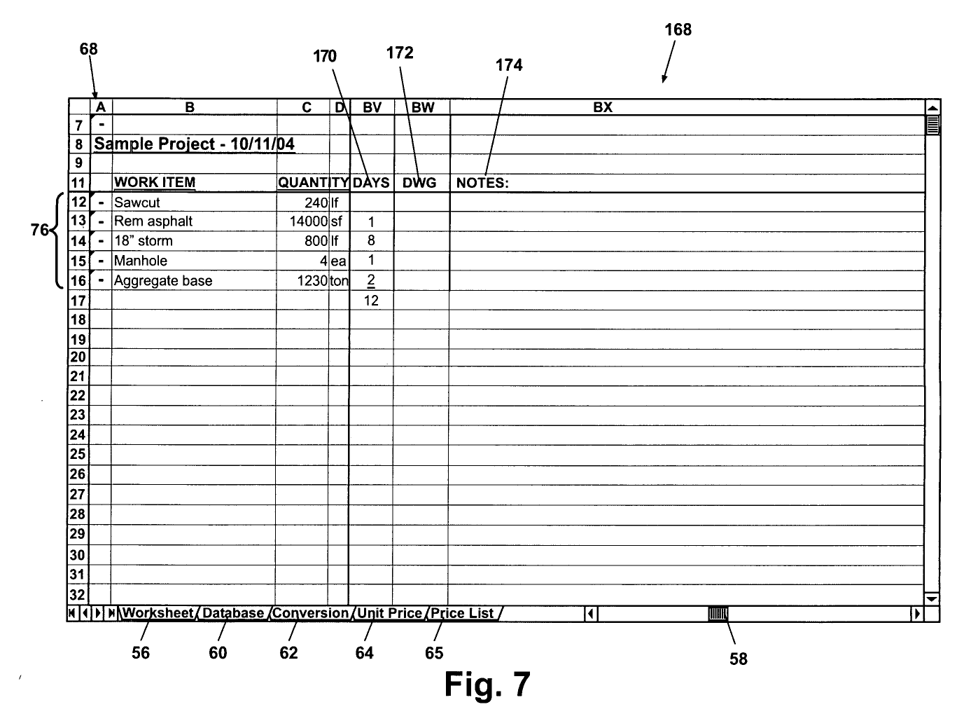

As best seen in reference to FIG. 7, a duration section 168 of worksheet 12 identifies the estimated number of days to complete each of the work items 76 identified by the user. Duration section 168 is viewed by scrolling selector bar 58 further to the right as viewed in FIG. 7 until column designators 68 having letters BV through BX of duration section 168 are visible. A number-of-days-to-complete 170 in column BV is entered automatically for each of the work items 76. A total is then shown in column BV, row 17, providing the total number of work days to complete the job. Duration section 168 also provides a drawing information column 172 in column BW and a user notes column 174 in column BX. Drawing information column 172 allows the user to enter known drawing information data such as the page where information may be found and a specific drawing. User notes column 174 permits the user to enter comments relating to individual ones of the work items 76. Data in column BV is calculated as further described in reference to Table 1 herein.

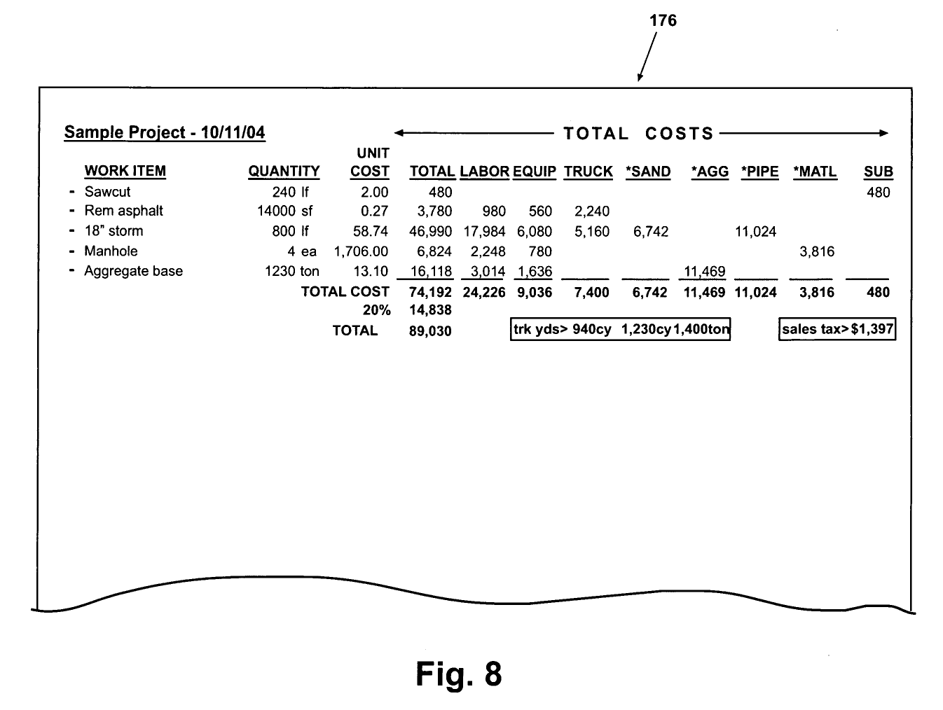

Referring now to FIG. 8, a total costs report 176 is shown. Total costs report 176 is the printed version of the information identified in FIG. 2 in total costs section 54. For ease of use the screen information shown on the user's computer monitor is sized so that columns displayed coincide with those of a printed report page. Blue fonts seen on the monitor serve only to designate cells that can be overwritten. For printing individual reports, any color visible in the individual sheets is turned off because the color serves no purpose for the printed report. Column lines, column numbers, designation letters and remaining border information is also turned off for printing reports such as total costs report 176.

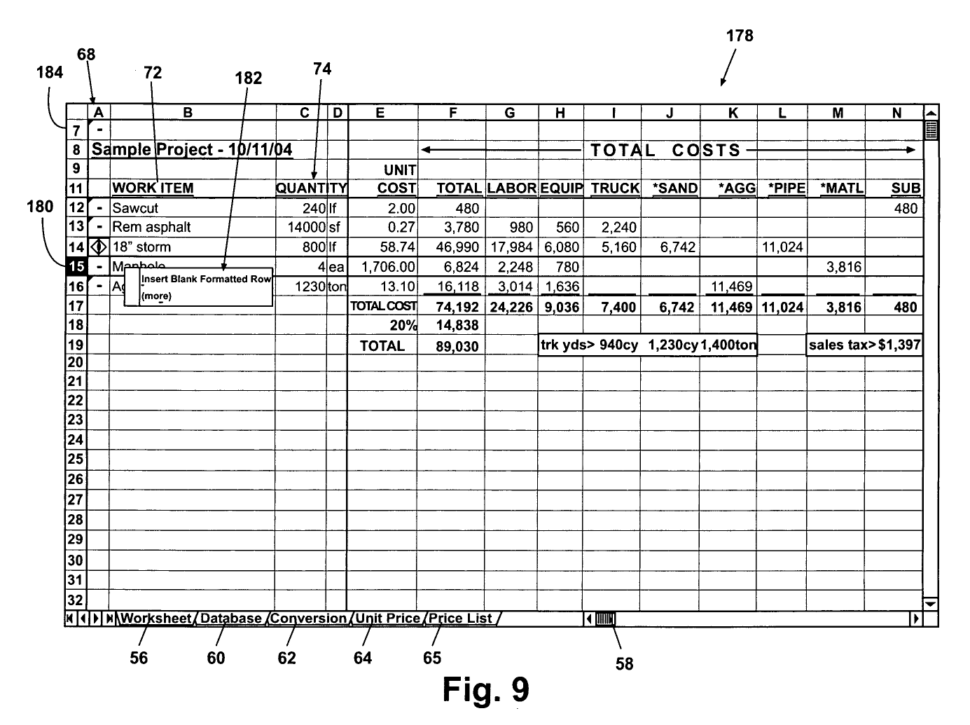

Referring now to FIG. 9, an insertion page 178 identifies how a new work item is inserted into the individual sheets of the present disclosure. Data is never entered in row seven (7) of the worksheet or worksheet section because row seven (7) provides a master row 184 which is pre-formatted and prepared to be copied by the user to add additional blank work item rows. The user can add or insert a formatted row by copying row seven (7) to a designated location. In the example shown, to insert a new row between existing work items, an exemplary row 180 is selected by the user which produces a pop-up insert window 182. The user selects the “insert-blank-formatted-row” instruction and clicks this instruction in pop-up insert window 182 to automatically copy master row 184 from row seven for insertion of an additional work item. This process can be repeated for as many new work items as desired. By using or copying master row 184, cell formulas are placed in the appropriate columns. Default values of the units associated with quantity column 74 will also appear based on predetermined values stored in estimating program 10 or modified units selected by the user.

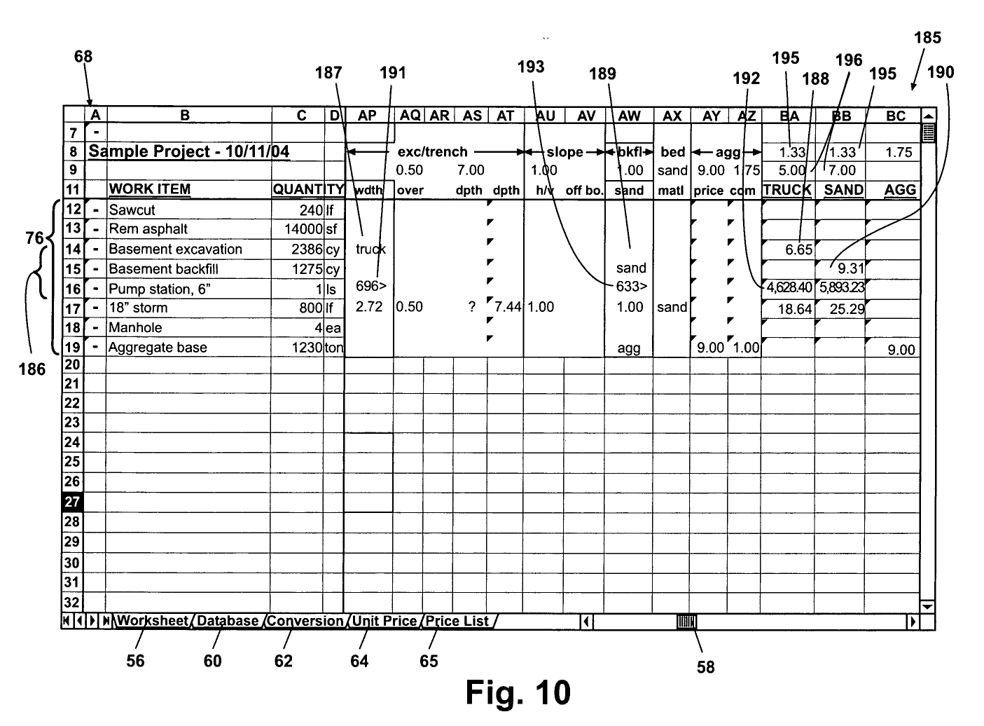

As best seen in reference to FIG. 10, a volume calculation section 185 is similar to volume calculation section 130 of FIG. 5, which deals generally with trench volume calculations, but FIG. 10 has 3 new work items 186 inserted to show how columns AP and AW are able to provide excavation and fill source data respectively, for non-trench work items. Volume calculation section 185 includes column designator letters AP through BC of column designators 68. An item ‘truck’ 187 placed in column AP, either automatically by estimation program 10 or by the user, triggers a truck unit cost 188 for a new work item ‘basement excavation’ in column BA. An item ‘sand’ 189 inserted in column AW triggers generation of a sand unit cost 190 for the new work item ‘basement backfill’ and appears in column BB. A large quantity of excavation and sand backfill can also be included for new item ‘pump station’. By inserting a cubic yard excavation quantity (having a right arrow) 191 in column AP, a truck cost 192 is calculated and presented in column BA. Similarly, by inserting a cubic yard sand backfill quantity (with right arrow) 193 in column AW, a backfill cost 194 is calculated and presented in column BB. Default data in their respective columns for a truck to in-place-cubic-yard conversion factor 195 in row 8, and a truck yard price 196 in row 9, are also part of these calculations.

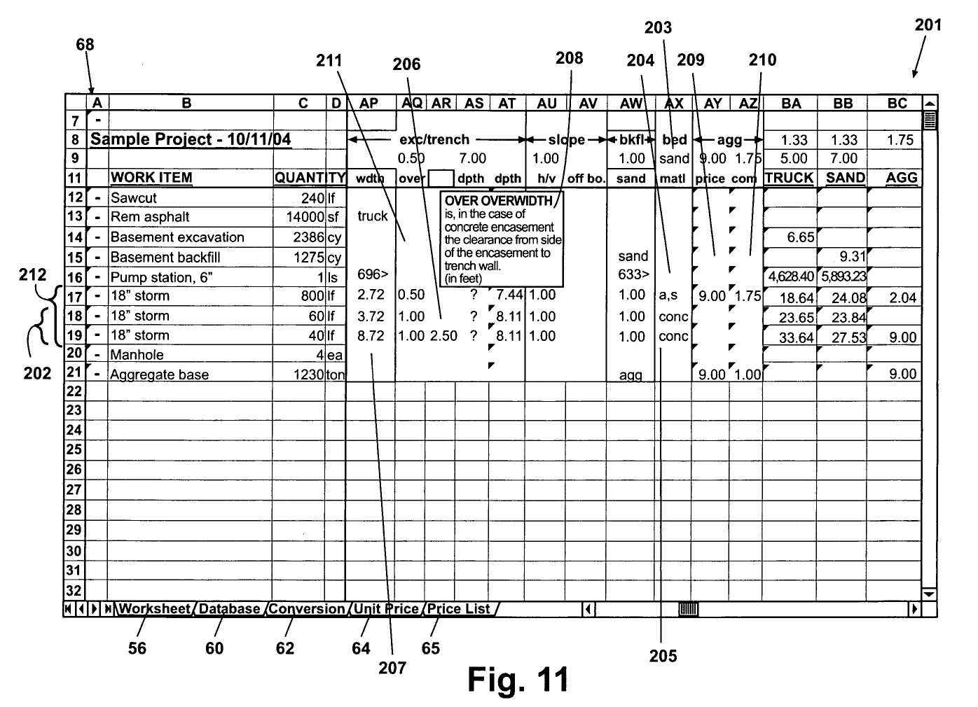

Referring next to FIG. 11, a volume calculation section 201, similar to volume calculation section 185 of FIG. 10, provides the same left hand information as seen on the previous sections such as total costs section 54. Two new work items 202 added to volume calculation section 185 as shown in volume calculation section 201 identify how estimating program 10 incorporates two other common types of pipe bedding material, ‘aggregate’ and ‘concrete encasement’. In this example, the user has overwritten the default bedding material, which is ‘sand’ 203, with an aggregate/sand designator 204, using the initial for sand bedding (s) below and the initial for aggregate bedding (a) above. The following two rows in column AX provide a concrete bedding 205. In row 19, the concrete encasement has been formed requiring a 2.5 foot working space 206 on each side of the encasement to allow workers to set forms. This entry causes an automatic revision of a trench width 207.

An information pop-up window 208 is exemplary of information which is provided by estimating program 10 when the user moves the cursor and selects any particular column heading or default number given in rows nine and 11. Information pop-up window 208 provides a brief description of the column information. Volume calculation section 201 further includes an aggregate price 209 in column AY and an aggregate cubic yard conversion factor 210 in column AZ. A clearance-about-pipe 211 in column AQ corresponds to a clearance on either side of the pipe. Working space 206 similarly corresponds to a clearance on either side of the encasement. Bedding material in column AX is selected from a plurality of material types including sand, aggregate, concrete or any combination of two of these materials. Conversion factor 210 provides a conversion factor (for example from tons to cubic yards) for the selected material.

In the example shown, multiple item entries 212 of an 18 inch storm pipe are provided each having individual quantities given in linear feet. Multiple item entries 212 are provided to demonstrate the capability of estimating program 10 to differentiate similar work items where individual criteria varies such as trench width, backfill material, bedding material and/or trench slope. Values for each of the columns of trucking, sand and aggregate are provided to the right in volume calculation section 201 for each of the work items shown.

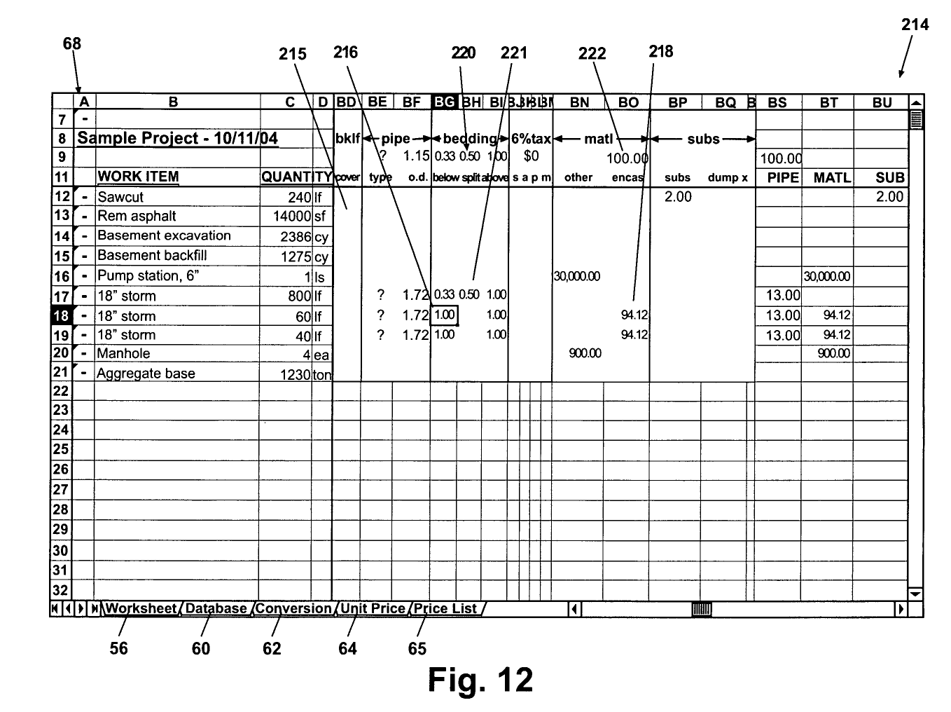

Referring now to FIG. 12, a pipe/material/subcontracts section 214 of worksheet 12 further identifies additional source data required for volume calculation section 201. Pipe/material/subcontracts section 214 similarly provides the left hand information of the previous sections such as total costs section 54 as well as columns BD through BU. Pipe/material/subcontracts section 214 includes pipe type and outside diameter in columns BE and BF, and bedding thickness below and above the pipe (in feet) in columns BG and BI respectively. An actual encasement thickness 216 entered by the user is shown for example in column BG. The user has entered a value for the actual encasement thickness 216 below the pipe. The user is also able to differentiate a split of material as a percentage using split-of-aggregate/sand 220 for values appearing in column BH. For example, the value of 0.50 as item 221 indicates an even split between aggregate and sand material to be positioned at the pipe midpoint. Cost-of-encasement 218 is determined by estimating program 10 using a value inserted by the user, for example a cost of concrete per cubic yard. In the example shown, a cost of $100 per cubic yard has been entered as a default number 222, which when combined with calculations made in the volume calculation section results in a $94.12 value for the cost-of-encasement 218.

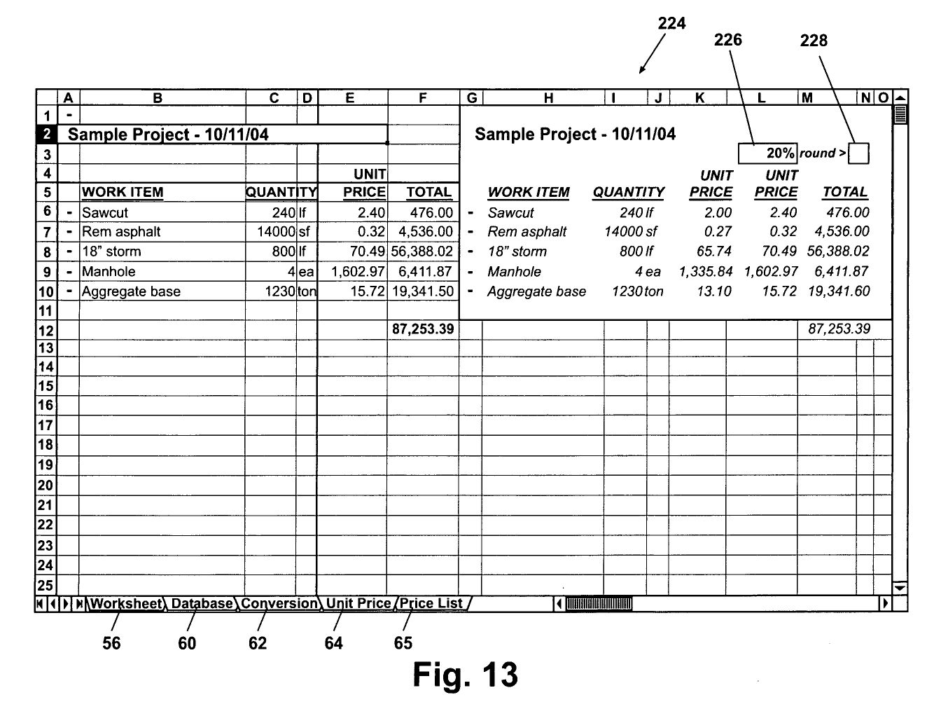

Referring now to FIG. 13, an unit-price sheet 224 provides an estimate in unit prices instead of a lump sum. The right half of the unit-prices sheet 224 includes unit costs copied directly from the previous section with the addition of unit prices in a column “L”. Unit price is equal to a unit cost plus a percent markup 226 displayed in cell “L3”. The percent markup 226 is a value input by the user which increases the unit cost value for each work item listing to incorporate a profit value (as a percentage) that the estimator desires to use. Duplication of data in columns “A” through “F” allows the user to make adjustments or round prices while at the same time being able to view calculated prices from the worksheet. If printed, only columns “A” through “F” appear, therefore the desired profit identified by percent markup 226 is not reproduced. If the user inputs an “X” in a rounding designator box 228, unit price values shown in column “E” are rounded.

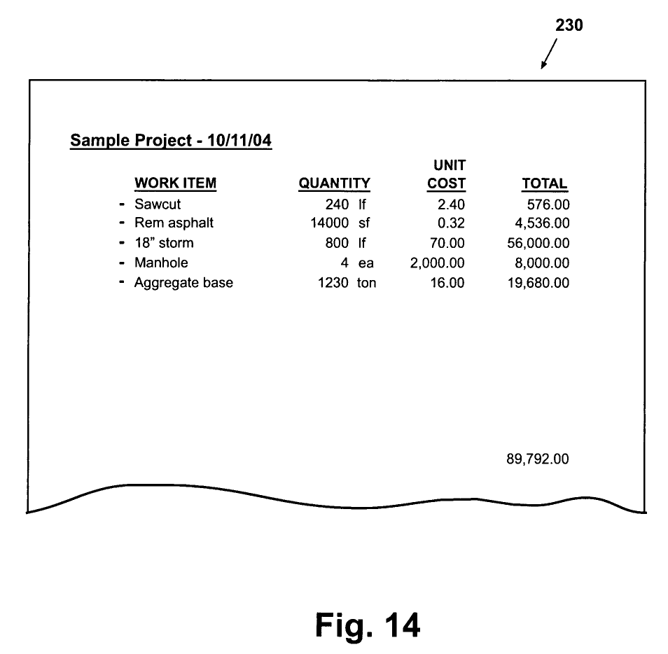

Referring next to FIG. 14, a unit price printout 230 identifies the data shown in columns “A” through “F” of unit-prices sheet 224. The appearance of unit price printout 230 is similar to total costs report 176, having row and column lines as well as row and column numbers and letters turned off. Any color or shading of unit-prices sheet 224 is also turned off.

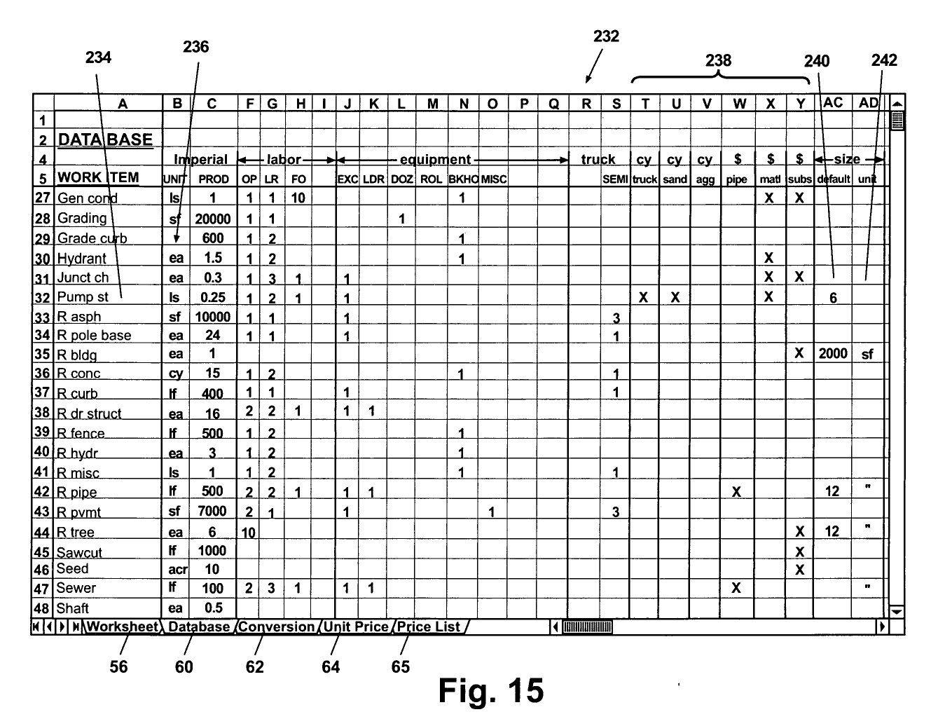

As best seen in reference to FIG. 15, a database sheet 232 is available to the user when database tab 60 is selected. Database sheet 232 includes a work item list 234 having a complete list provided in alphabetical form of all of the work items saved in the database of estimating program 10. Estimating program 10 is initially pre-loaded with a plurality of industry standard or commonly known work items when the user first loads and actuates estimating program 10. Thereafter, work items can be modified/removed, or additional work items entered and saved in database sheet 232. Database sheet 232 also includes an item unit column 236 showing an item unit selected by the user. Data in database sheet 232 is associated with labor, equipment and trucking (columns F through Q) the user wants to retrieve when a particular work item is entered in worksheet 12. A plurality of data in columns 238 designated with an “X” are not stored as hard numbers, but as formulas created by regression analysis and/or extrapolation. By right-clicking on any cell containing an “X”, a pop-up window appears which displays the data (explained in the following paragraph). If the user wants a default size to apply, even though a size is not included when the work item is entered in column B or work item column 72 of the worksheet, a default size 240 will be used in the database provided the size was entered as a default size 240 in column “AC” of the database sheet 232.

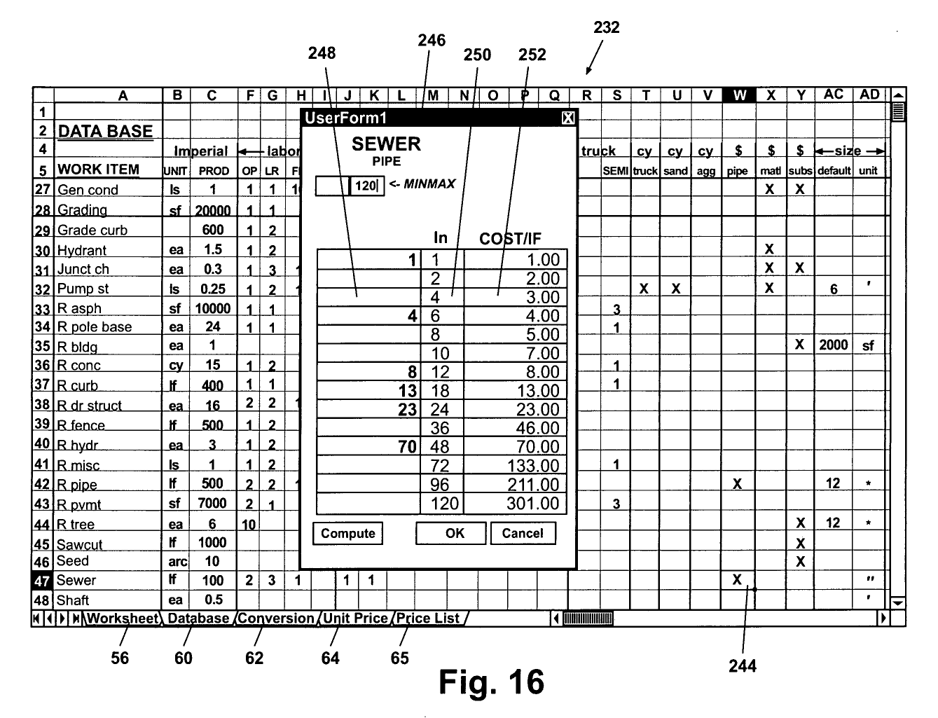

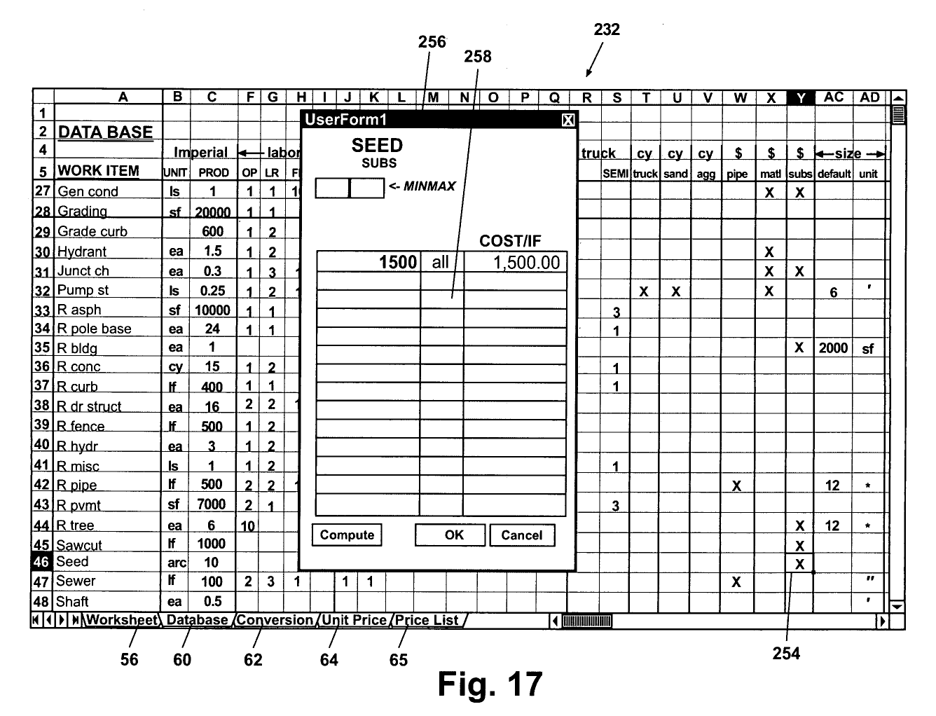

For estimating program 10, certain Pop-up windows are provided in two different formats, one for work items having different sizes as shown in FIG. 16, and a second for work items that are not designated by a size as shown in FIG. 17. If a work item has different sizes the unit size is automatically entered, for example, inch (″), feet (′), square feet (sf), etc. for a plurality of size units 242 of a size 240 in column “AC” of database sheet 232.

As shown in FIG. 16, while working in database data sheet 232, if the user selects any of the columns identified having an “X” within such as sewer item 244 in “sewer” work item row 47 and pipe column “W”, a pop-up window 246 appears. Pop-up window 246 is in a predefined form, which in the example shown identifies a sewer pipe and provides an area where the user can enter data 248. A user predetermined range of sizes 250 is also provided. A cost 252 for each item listed in pop-up window 246 is provided as follows. When entering user entered data 248, the user also provides a cost for not fewer than two of the sizes 250 shown. Estimating program 10 interpolates a cost for each item bounded between any two entered values of user entered data 248. Estimating program 10 extrapolates a cost for each item larger or smaller than either the largest or smallest entered value of user entered data 248. For example, the cost of the 120 inch size of sewer pipe identified in pop-up window 246 is an extrapolated value because the largest size having a value entered by the user is 48 inches. The cost for a 36 inch sewer pipe identified in pop-up window 246 is interpolated by estimating program 10 because a 36 inch sewer pipe size is bounded within the values entered by the user for 24 inch and 48 inch sewer pipe sizes, respectively. Subsequently, for any size sewer pipe desired by the user, costs per unit size are either interpolated or extrapolated even if they are not definitively provided by values entered by the user in area 248 of pop-up window 246.

Referring now to FIG. 17, while also working in database data sheet 232, if the user selects a cell having an “X” entered, which corresponds to a work item having no range of sizes, a pop-up window such as exemplary pop-up window 256 appears. In this example, pop-up window 256 identifies a work item 242 “seed”. There is no generic column of sizes for the work item “seed” and no size unit entered in database 232, therefore a size range column 258 includes only the designator “ALL”. Any cost entered by the user into pop-up window 256 results directly in a cost per the unit equal to the cost entered. By accessing pop-up windows such as pop-up window 256, the user also has the capability of changing the cost per item which affect all other uses of the item in an estimate. Once a cost is entered, the user selects “Compute” to update the individual pop-up window and the database of estimating program 10, and then selects “OK” to save the data for future use. The pop-up window can then be closed to allow further access to database data sheet 232.

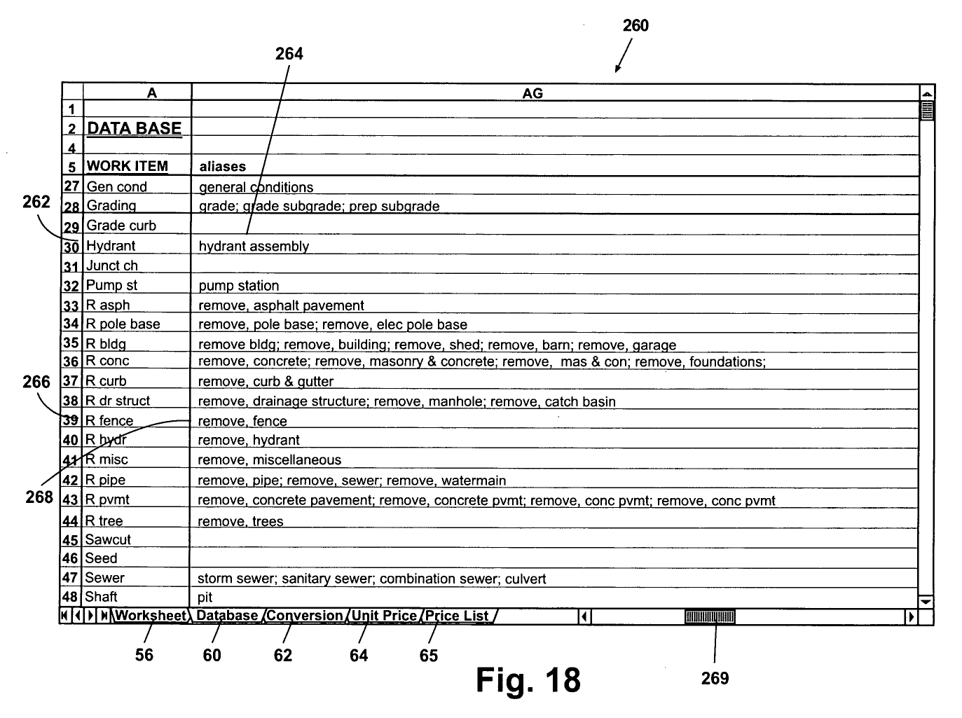

Referring to FIG. 18, a table of aliases 260 is available for input by the user into estimating program 10. The use of aliases allows the user to use multiple, local, common, or abbreviated names for any of the work items in the database. For any work item, the user can enter one or more aliases, any of which are then recognized by estimating program 10. Estimating program 10 retrieves data upon recognition of any work item name or alias having one of the aliases identified of table of aliases 260 providing that the alias is unique meaning it is not applied to more than one work item. In the example shown in FIG. 18, a base name 262 of “hydrant” is a work item identified in the database. The user has entered an alias “hydrant assembly” 264. Similarly, the database contains an abbreviated name “R fence” 266. The user has entered an alias name equating the abbreviated name “R fence” to “remove fence” 268. Table of aliases 260 can be accessed at any time to add or remove aliases for any of the work items by selecting database tab 60 and using a scroll tab 269 to view the list of aliases in column “AG”.

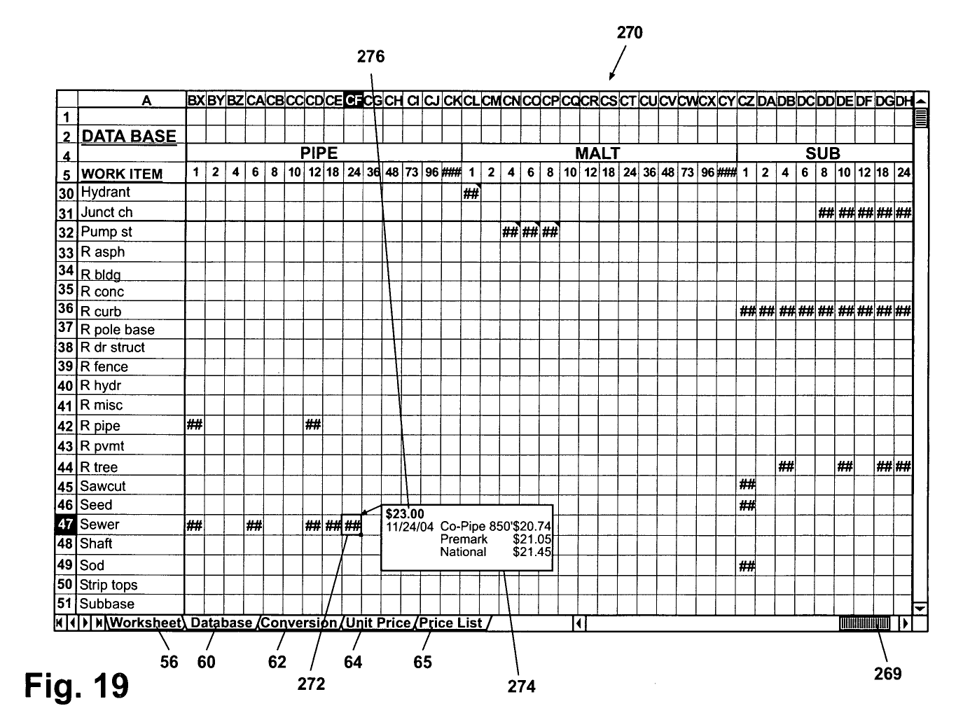

Referring next to FIG. 19, a price history table 270 is shown. Price history table 270 is an optional section. It is accessed by selecting database tab 60 and scrolling to the right using scroll tab 269 until columns “BX” through “DM” appear. Where a double pound-sign (##) symbol is provided in any cell of price history table 270, data is provided which can be accessed and modified by the user. For example, by selecting a cell 272 for a work item number 47 corresponding to a sewer pipe having a size of 24 inches an example of a typical Excel comment window 274 appears.

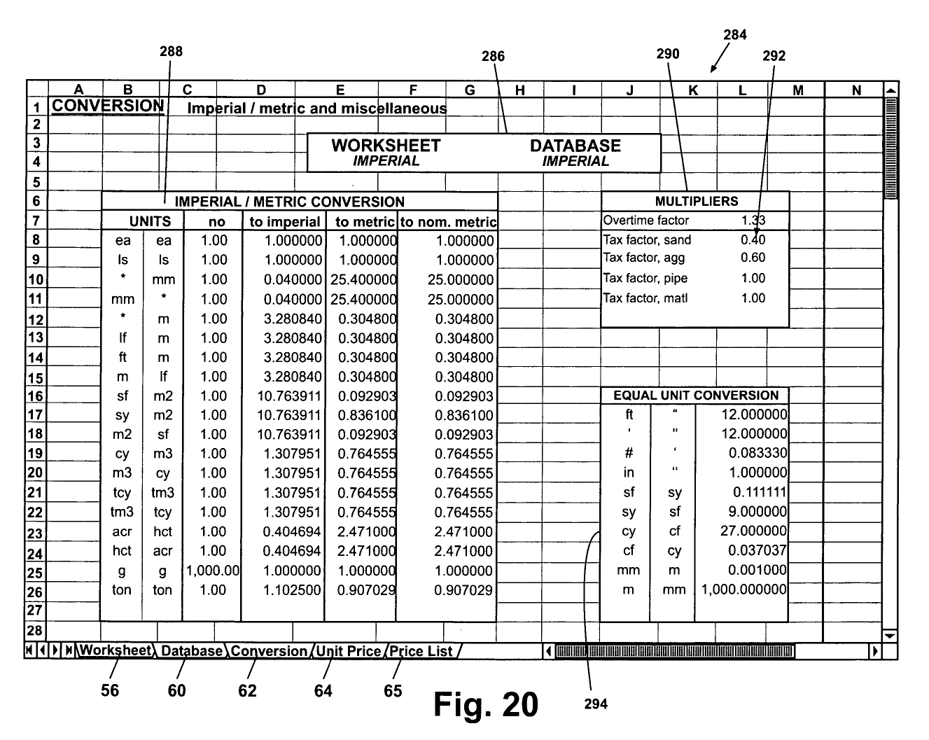

Referring now to FIG. 20, if the user selects conversion tab 62, a conversion sheet 284 appears on the screen. Conversion sheet 284 includes an identification box 286 which shows the user the unit type which is currently used by each of the worksheets and currently selected for use by the database. In the example shown, Imperial units are identified for each of the worksheet and database. Identification box 286 permits the user to change between unit types. For example, the user can change from the Imperial units shown to metric or United States units. Conversion table sheet 284 therefore also provides a plurality of conversion tables including an Imperial/metric equal unit conversion table 288. A multiplier table 290 provides factors for calculating taxes as well as overtime rates. Multiplier table 290 therefore provides a plurality of multiplier values 292 associated with each factor. An equal unit conversion table 294 is also provided. Equal unit conversion table 294 provides conversion factors for converting a plurality of units to similar units. For example, equal unit conversion table 294 provides the conversion factor for converting square feet to square yards. For tax factors identified in multiplier table 290, each tax factor identifies taxes to be applied (1) totally, (2) not applied, or (3) only partially applied to any costed item. For example, a tax can apply to all costs of a work item such as pipe, but may only apply to a material portion of work items such as “sand” or “aggregate” but not apply to hauling sand or aggregate materials. Use of the tax factor therefore permits the user to identify what percentage of each work item such as sand is taxable.

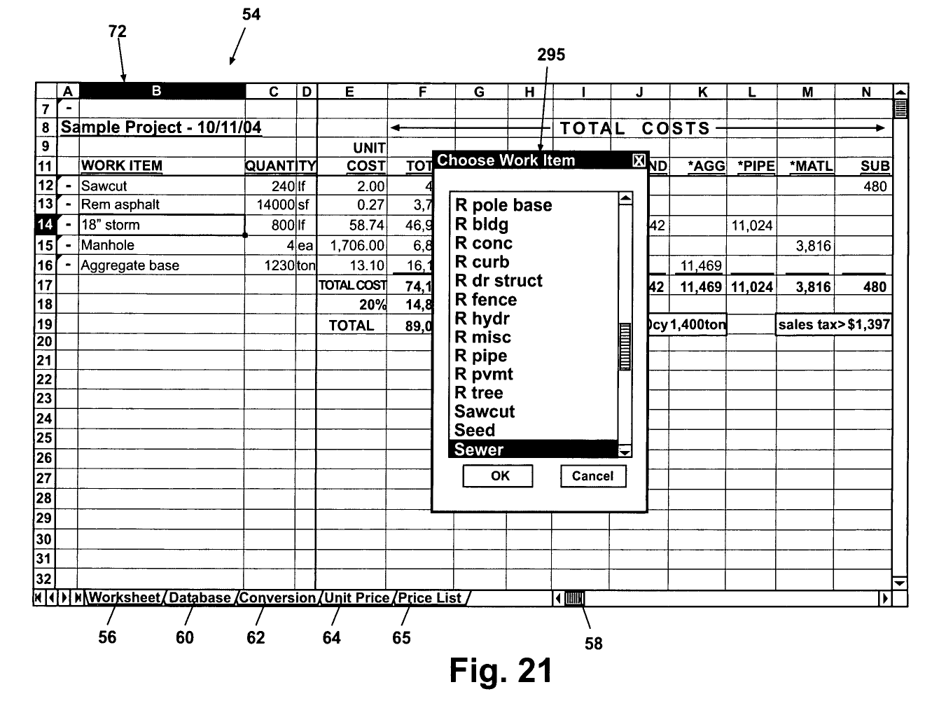

Referring next to FIG. 21, a pop-up window 295 displays work items stored in the database. Pop-up window 295 appears (for example when working in worksheet 12, total costs section 54), when a work item entered in work item column 72 is recognized as more than one work item in the database (caused for example by an ambiguous name in the database, which can be corrected by the user at a more convenient time). When pop-up window 295 appears, one of the ambiguous work item names is highlighted. The user can either accept the work item which is highlighted, scroll the menu until the desired work item is located and accepted, or cancel the pop-up window 295 which at the same time cancels the item of work just entered in the sheet. The user is also able to cause pop-up window 295 to appear by right-clicking an input device such as a mouse while a selector indicator is positioned on a work item in work item column 72 (in this example ‘18″ storm’).

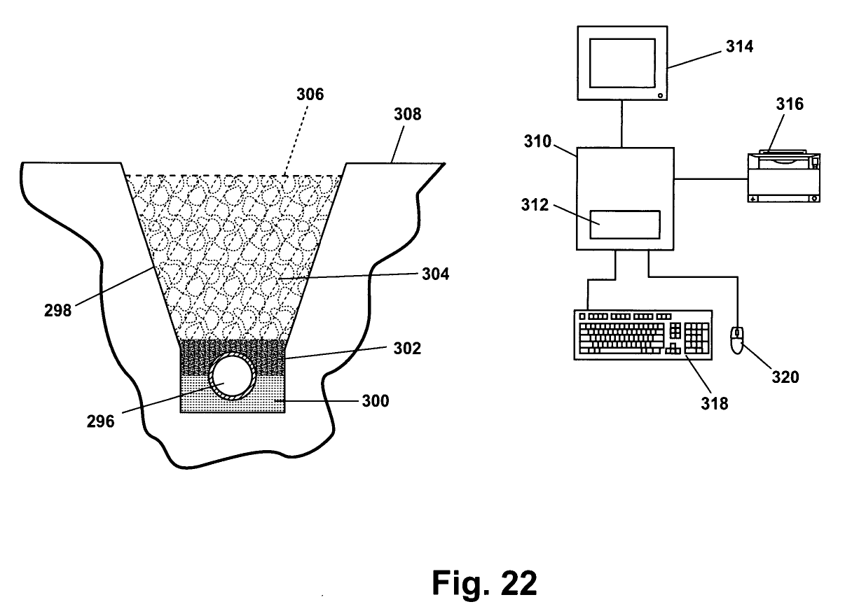

Referring now to FIG. 22, a diagrammatic view of estimating program 10 includes an exemplary buried pipe 296, a bedding of aggregate 300, sand 302, and backfill 304. Backfill 304 can be brought up to a grade 306 below a ground level 308 and is referred to as “backfill cover”. A computer 310 has estimating program 10 loaded into a memory 312. Estimating program 10 operates as a template for Microsoft™ EXCEL. A user can view data using a viewing device 314 and/or print or show data via an output device 316. Data can be input or modified using estimating program 10 via a first input device 318 such as a keyboard and/or a second input device 320 such as a mouse. The devices shown are provided as examples only and do not limit the types of devices which can be used to enter, manipulate, view or output data for estimating program 10. Estimating program 10 can be provided for downloading into computer 310 on a portable memory device such as a CD ROM or one or more floppy discs.

Referring to Table 1 below, operations performed on identified columns of data are identified. An ‘X’ in the User Enter column indicates cells that the user can enter data into. An ‘X’ in the YES column of the ‘Overwrite Possible?’ query identifies columns of cells that can be overwritten by the user. An ‘X’ in the NO column of the ‘Overwrite Possible?’ query identifies columns of cells that cannot be overwritten by the user. A column designator identified with an asterisk is a “hidden” column of data which is provided in the database, but not visible to or directly accessible by the user. These columns are used to manipulate data for subsequent use in other columns and/or to produce the printable total cost estimate.

Columns at the right side of Table 1 generally describe the cell, area of the database or column where data shown at the column identified to the left is read or derived from. Data in the “hidden cells of the database” is directly read from the database sheet or derived from one or more formulas in the database that combine the data from the identified columns or cells. The data can be derived using a plurality of formulas that will be obvious to the skilled practitioner. For example, an exemplary formula to derive the data identified in column CP is:
=IF(CG13>0,IF(OR(AT13−BD13<CG13,AT13−BD13<BG13+BF13),IF(AND(AT13−BD13<CG13,AT13−BD13<BG13+BF13),(AT13−BD13−BG13)/BF13,IF(CG13<BG13+BF13,(CG13−BG13)/BF13,(AT13−BD13−BG13)/BF13)),IF(CG13<BG13+BF13,(CG13−BG13)/BF13,1)),0)
Similarly, an exemplary formula to derive the data identified in column DR is:
=IF(DS13=0,VALUE(getVectorElement(DQ13,0)),DS13)

TABLE 1
COLUMN DESCRIPTION

| Col. | Function | User | Overwrite | | |
|---|---|---|---|---|---|
| WORKSHEET | Description | Enter | Yes | No | General source of data |

Section 54 TOTAL COST SECTION

| | | | | | |
|---|---|---|---|---|---|
| A | Line number (optional) | X | | | (dash) |
| B | Work Item | X | | | (blank) |
| C | Quantity | X | | | (blank) |
| D | Unit | | X | | DATABASE B |
| E | Unit Cost of Work Item | | | X | O |
| F | Total Cost of Work Item | | | X | sum of O thru N |
| G | Total Labor Cost of Work Item | | | X | C × P |
| H | Total Equipment Cost of Work Item | | | X | C × Q |
| I | Total Trucking Cost of Work Item | | | X | C × R |
| J | Total Sand Cost of Work Item | | | X | C × S |
| K | Total Aggregate Cost of Work Item | | | X | C × T |
| L | Total Pipe Cost of Work Item | | | X | C × U |
| M | Total Material Cost of Work Item | | | X | C × V |
| N | Total Subcontractor Cost of Work Item | | | X | C × W |

Section 114 UNIT COST SECTION

| | | | |
|---|---|---|---|
| O | Unit Cost of Work Item | X | sum of P thru W |
| P | Labor Unit Cost of Work Item | X | M ÷ X |
| Q | Equipment Unit Cost of Work Item | X | N ÷ X |
| R | Trucking Unit Cost of Work Item | X | (AO ÷ X) + BA |
| S | Sand Unit Cost of Work Item | X | BB + BJ8 × CONVERSION K8 |
| T | Aggregate Unit Cost of Work Item | X | BC + BJ8 × CONVERSION K8 |
| U | Pipe Unit Cost of Work Item | X | BS + BJ8 × CONVERSION K8 |
| V | Material Unit Cost of Work Item | X | BT + BJ8 × CONVERSION K8 |
| W | Subcontractor Unit Cost of Work Item | X | BU |

Section 118 LABOR AND EQUIPMENT SECTION

| | | | | |
|---|---|---|---|---|
| X | Production units per day | X | | DATABASE C |
| Y | Number of Tradesmen (Operators) | X | | DATABASE F |
| Z | Number of Tradesmen (Laborers) | X | | DATABASE G |
| AA | Number of Tradesmen (Foremen) | X | | DATABASE H |
| AB | Number of Tradesmen (blank) | X | | DATABASE I |
| AC | Number of Equipment (Excavators) | X | | DATABASE J |
| AD | Number of Equipment (Loaders) | X | | DATABASE K |
| AE | Number of Equipment (Dozers) | X | | DATABASE L |
| AF | Number of Equipment (Rollers) | X | | DATABASE M |
| AG | Number of Equipment (Backhoes) | X | | EW, DATABASE N |
| AH | Number of Equipment (Miscellaneous) | X | | EW, DATABASE O |
| AI | Number of Equipment (blank) | X | | EW, DATABASE P |
| AJ | Number of Equipment (blank) | X | | EW, DATABASE Q |
| AK | Number of Trucks (blank) | X | | EW, DATABASE R |
| AL | Number of Trucks (Semis) | X | | EW, DATABASE S |
| AM | Total Daily Labor Cost | | X | X9 × (Y9 × Y + . . . + AB9 × AB) |
| AN | Total Daily Equipment Cost | | X | X9 × (AC9 × AC + . . . + AJ9 × AJ) |
| AO | Total Daily Trucking Cost | | X | X9 × (AK9 × AK + AL9 × AL) |

Section 130 VOLUME CALCULATION SECTION

| | | | | |
|---|---|---|---|---|
| AP | Trench Width yards or units excavation | X | | AR9 |
| AQ | Overwidth | X | | AQ9 |
| AR | Over Overwidth, when encasement | X | | (blank) |
| AS | Depth | X | | AQ9 |
| AT | Depth, Adjusted | X | | AS + BF + BG |
| AU | Slope (horizontal to vertical) | X | | AU9 |
| AV | Off the Bottom (beginning of slope) | X | | AV9 |
| AW | Trench (portion of sand backfill) yds fill | X | | AW9 |
| AX | Bedding Material | X | | AX9 |
| AY | Aggregate, price per ton | X | | AY9 |
| AZ | Aggregate, conversion tons to yards | X | | AZ9 |
| BA | Trucked out excavation, cost per unit | | X | BA8 × BA9 × (AP or CJ + CK + CI) |
| BB | Sand trucked in, cost per unit | | X | BB8 × BB9 × (AW or CJ + CK + CL − CI) |
| BC | Aggregate trucked in, cost per unit | | X | BC8 × BC9 × (AW or CJ + CK + CL − CI) |

Section 154 PIPE, MATERIAL & SUBCONTRACTOR SECTION

| | | | | | |
|---|---|---|---|---|---|
| BD | Cover, above backfill | | X | | BD9 |
| BE | Pipe, type | | X | | BE9 |
| BF | Pipe, outside diameter | | X | | BF9 × CV(dia) |
| BG | Bedding thickness below pipe | | X | | BG9 |
| BH | Split between bedding materials | | X | | BH or blank |
| BI | Bedding thickness above pipe | | X | | BI9 |
| BJ | Mark (x) if sand vendor included tax | X | | | (blank) |
| BK | Mark (x) if aggregate vendor included tax | X | | | (blank) |
| BL | Mark (x) if pipe vendor included tax | X | | | (blank) |
| BM | Mark (x) if material vendor included tax | X | | | (blank) |
| BN | Material, other | | X | | DH |
| BO | Material, encasement | | X | | BO9 × (CJ + CK) |
| BP | Subcontracts | | X | | DI |
| BQ | Dump fees, at landfills | | X | | BQ9 × (BA ÷ BA9) |
| BR | Dump fee switch, mark (x) if on | | X | | BR9 |
| BS | Pipe price per unit | | X | | DG |
| BT | Material price per unit | | | X | BN + BO |
| BU | Subcontract price per unit | | | X | BP + BQ |

Section 168 DURATION & REMARKS

| | | | | |
|---|---|---|---|---|
| BV | Work Item days to complete | | X | C ÷ X |
| BW | Drawing numbers (optional) | X | | (blank) |
| BX | Remarks (optional) | X | | (blank) |

*Hidden Cells In Database

| | | | |
|---|---|---|---|
| *BY | Trucked out Excavation, total truck yrds | X | BA, BA9, C |
| | | | *cells are hidden |
| *BZ | Sand trucked in, total truck yrds | X | BB, BB9, C |
| *CA | Aggregate trucked in, total tons | X | AY, BC, C |
| *CB | Total tax | X | BB, BC, BJ8, BS, BT, C, CONVERSION |
| *CC | Total adjusted tax (not paid by vendor) | X | BB, BC, BJ, BJ8, BK, BL, BM, BS, BT, C, |
| | | | CONVERSION |
| *CD | Bedding, location of comma | X | AX |
| *CE | Bedding, 1st | X | AX, CD |
| *CF | Bedding, 2nd | X | AX, CD |
| *CG | Bedding, 1st bed height | X | AT, AX, BD, BF, BH, BG, BI, CF |
| *CH | Bedding, 2nd bed height | X | AT, BD, BF, BG, BH, BI, CF, CG |
| *CI | Pipe area | X | BF, CW |
| *CJ | Bedding, 1st bed area | X | AB, AF, AU, AV, AX, BF, CG, CQ |
| *CK | Bedding, 2nd bed area | X | AP, AR, AU, AV, CF, CG, CH, CJ, CS |
| *CL | Sand trench backfill | X | AP, AT, AU, AV, AW, BD, BS, CJ, CK |
| *CM | Trench excavation | X | AP, AT, AU, AV, AW, BD |
| *CN | Calculator valadation | X | AP, AQ, AS, AS1, B, C, |
| *CO | Calculator computations | X | AP, AQ, AS, AU, AV, C, CW |
| *CP | Part of pipe, 1st bed portion | X | AT, BD, BF, BG, CG |
| *CQ | Part of pipe, 1st bed area | X | BF, CP |
| *CR | Part of pipe, Backfilled portion | X | AT, BD, BF, BG |
| *CS | Part of pipe, Backfilled area | X | BF, CR |
| *CT | (not used) | X | (blank) |
| *CU | Work Item name | X | DR, DATABASE |
| *CV | Work Item size | X | DA, DB |
| *CW | Work Item size multiplier | X | CV, DQ |
| *CX | Work Item size unit | X | DR, DATABASE |
| *CY | Work Item entered size unit | X | DQ |
| *CZ | Work Item entered size | X | DQ |
| *DA | Work Item scaled size | X | CZ, DP |
| *DB | Work Item default size | X | CZ, DR, DATABASE |
| *DC | Vector element | X | DQ |
| *DD | Truck number | X | CV, DD9, DR, DATABASE |
| *DE | Sand number | X | CV, DE9, DR, DATABASE |
| *DF | Aggregate number | X | CV, DF9, DR, DATABASE |
| *DG | Pipe number | X | CV, DG9, DR, DATABASE |
| *DH | Material number | X | CV, DH9, DR, DATABASE |
| *DI | Subcontractor number | X | CV, DI9, DR, DATABASE |
| *DJ | Validation for column AP | X | D, AP, AS, AU, AV, AW, AX, BE |
| *DK | Validation for column AT | X | D, AP, AS, AU, AV, AW, AX, BE |
| *DL | Validation for column AU | X | D, AP, AW, AX, BE |
| *DM | Validation for columns AR, AS, & AV | X | D, AP, AW |
| *DN | (not used) | X | (blank) |
| *DO | (not used) | X | (blank) |
| *DP | Unit conversion | X | CX, CY, CONVERSION |
| *DQ | Parser | X | B, DATABASE, CONVERSION |
| *DR | Work Item number | X | DS, DQ |
| *DS | Work Item number override | X | DR |

DATABASE SHEET 14

(blank)

CONVERSION SHEET 20

(blank)

UNIT PRICE SHEET 16

| | | | | |
|---|---|---|---|---|
| A | Line Number | X | | G |
| B | Work Item | X | | H |
| C | Quantity | X | | I |
| D | Unit | X | | J |
| E | Unit Price | X | | K |
| F | Total | X | | C × E |
| *G | Line Number | | X | WORKSHEET A |
| | | | | *cells are hidden |
| *H | Work Item | | X | WORKSHEET B |
| *I | Quantity | | X | WORKSHEET C |
| *J | Unit | | X | WORKSHEET D |
| *K | Unit Price | | X | K × (1 + K3) |
| *L | Total | | X | I × K |
| *M | Unit Cost | | X | WORKSHEET E |

PRICE LIST SHEET 18

| | | | | |
|---|---|---|---|---|
| A | | | | (blank) |
| B | | | | (blank) |
| C | Size | X | | (blank) |
| D | Price | | X | J2, J3, DATABASE |
| | | | *X | *cells are hidden |
| | | | *X | |

A computer program for estimating excavation and piping systems of the present disclosure provides several advantages. By using a spreadsheet format rather than a large database for the computer program, a user can enter and modify data quickly and in fewer steps than are required for programs of similar nature. By reducing the size of database tables and using formulas to either interpolate or extrapolate information based on limited user input, the program is made simpler and better suited to performing both rough and finished estimates. By limiting the number of worksheets, data sheets and report pages required for the estimating program of the present disclosure, total user time to produce an estimate is reduced. The program also provides the benefit of pop-up windows providing explanations and/or additional data to the user, when desired, by selecting individual cells of the sheets. This hides most of the data and formulas of the program from the user when the user does not require them but provides easy access when necessary.

The description of the present disclosure is merely exemplary in nature and, thus, variations that do not depart from the gist of the disclosure are intended to be within the scope of the disclosure. For example, the preparation of cost estimates for piping and excavation systems is described herein. The computer program of the present disclosure is not limited to piping and/or excavation systems, and can be applied to construction and/or contracting estimates in general, including but not limited to hauling, material supply/removal, paving, site grading, etc. Such variations are not to be regarded as a departure from the spirit and scope of the disclosure.

What is claimed is:

1. A computer program for performing contractor estimates, the program comprising:
a plurality of data sheets each having a plurality of data cells;
a plurality of work items displayable in predetermined ones of the plurality of the data cells and selectable by the user for management of a plurality of work items;
at least one user inputted work item cost expandable by the program using a regression analysis into a plurality of work item costs; and
an estimated project cost operably created when the user inputs a minimum of a work item name and a work item quantity.

2. The program of claim 1, wherein one of the data sheets further comprises a database sheet defining a plurality of characteristics for each of the plurality of work items, wherein multiple ones of the work items are pre-loaded in the database sheet when the user initially starts the program.

3. The program of claim 2, further comprising a plurality of unique alias names each assignable to a selected one of the plurality of work items.

4. The program of claim 2, further comprising a plurality of pop-up windows selectively viewable by the user and operable to modify the characteristics of the work items.

5. The program of claim 1, further comprising a first pop-up window having a plurality of pre-loaded work item names selectable by the user.

6. The program of claim 1, wherein the plurality of data sheets are divisible in a spreadsheet format into two groups including a first group operable as read-only data sheets and a second group having user accessible data cells.

7. The program of claim 1, further comprising at least one of an extrapolation function performed with the regression analysis and an interpolation function operable to create the plurality of work item costs.

8. The program of claim 1, wherein:
at least one section of one of the data sheets includes a user determined tax applicable to at least one of the data items; and
at least a second section includes an hourly rate operable with at least quantity of workers and a quantity of machines to determine a total worker cost and a total machine cost.

9. The program of claim 1, further comprising a plurality of pre-defined data default values, the data default values including at least a plurality of data units for a plurality of work item characteristics.

10. A computer program having software for use in a piping and excavation system cost estimating process, the software operated according to the steps comprising:
choosing a first data sheet designated as a worksheet from a plurality of data sheets;
entering a work item having at least a work item name and a work item quantity on the worksheet;
calculating at least one of an interpolated cost and an extrapolated cost for the work item; and
creating a total costs report.

11. The computer program of claim 10, further comprising repeating the entering, selecting and calculating steps for each of a plurality of work items.

12. The computer program of claim 11, further comprising segregating the cost for each of the plurality of work items into a labor, an equipment, a trucking, a sand, an aggregate, a piping, a material and a subcontracts cost.

13. The computer program of claim 11, further comprising selecting a second data sheet designated as a database sheet operable to display each of the plurality of work items.

14. The computer program of claim 10, further comprising selecting a third data sheet designated as a conversion sheet, the conversion sheet having at least one conversion table operable to convert a work item unit of measure between at least two measurement systems.

15. The computer program of claim 10, further comprising saving the computer program on a portable memory device.

16. The computer program of claim 10, further comprising entering the work item using at least one user controlled input device.

17. The computer program of claim 10, further comprising displaying at least the total costs report using an output device.

18. The computer program of claim 10, further comprising:
defining each of a plurality of original work item names and a plurality of alias names corresponding to individual ones of the original work item names;
saving the plurality of original work item names and the plurality of alias names in a database of the program;
entering a predefined alias name corresponding to a predetermined one of the original work item names; and
converting the alias name to the predetermined one of the original work item names prior to the calculating step.

19. A method for performing piping and excavation system estimates using a spreadsheet computer program, the method comprising:
choosing a worksheet from a plurality of data sheets;
entering at least one work item on the worksheet, the work item differentiable in at least two sizes each having a quantity;
selecting a pop-up window identifying a plurality of work cells;
inputting an item cost for each of the at least two sizes of the work item in individual ones of the plurality of work cells of the pop-up window;
calculating one of an interpolated cost and an extrapolated cost for at least a third size of the work item; and
creating a total costs report including each of the sizes of the work item.

20. The method of claim 19, further comprising segregating costs for each of a plurality of work items into a labor, an equipment, a trucking, a sand, an aggregate, a piping, a material and a subcontracts costs.

21. The method of claim 20, further comprising separating the labor costs into a plurality of crew member divisions.

22. The method of claim 20, further comprising separating the equipment costs into a plurality of equipment designators.

23. The method of claim 19, further comprising:
selecting a volume calculation sheet from the plurality of data sheets;
entering data into a first section of the volume calculation sheet, the data including at least a trench width entry, an oversize space entry, a depth-to-pipe entry, a slope-off-a-trench-wall entry, and a distance from a bottom of a trench to start of slope entry.

24. The method of claim 23, further comprising selecting a second section of the volume calculation sheet, the second section including at least a distance from top of trench to top of backfill entry, a pipe entry, an outside diameter of pipe entry, a thickness of bedding below pipe entry and a thickness of bedding above pipe entry.

25. The method of claim 19, further comprising calculating a job duration using a plurality of individual work item durations.

26. The method of claim 19, further comprising selecting between the item cost and a unit cost prior to creating the total costs report.

27. The method of claim 19, further comprising creating a master row for copying each of a plurality of blank work item rows into individual ones of the sheets.

28. A method for performing piping and excavation system estimates using a spreadsheet computer program, the method comprising:
loading the spreadsheet computer program into a computer database;
accessing a plurality of data sheets using the spreadsheet computer program, each including a plurality of data cells at least one accessible and viewable by a program user;
entering a plurality of user-defined data default values;
displaying a preselected group of piping and excavation system characteristics in predetermined ones of the plurality of data sheets for each of a plurality of work items;
performing a regression analysis to operably expand at least two user defined work item costs into a plurality of work item costs using one of an interpolation function and an extrapolation function;
generating a report having a plurality of item estimated costs; and
producing a project cost associated with a project name by a minimum entry defining an item name and an item quantity.

29. The method of claim 28, further comprising limiting insertion of data in selected ones of the data sheets to a plurality of rows and columns.

30. The method of claim 28, further comprising generating one of a plurality of pop-up windows when predetermined ones of the data cells are selected by the user.

31. The method of claim 30, further comprising providing a description of a column in at least one of the pop-up windows.

32. The method of claim 30, further comprising differentiating the pop-up windows in each of two formats, a first format including data identifiable in multiple sizes and a second format including data lacking a specific size.

33. The method of claim 28, further comprising entering a percent markup value for selected ones of the work items.

34. The method of claim 28, further comprising entering a designator in a predetermined one of the data cells operable to initiate a data rounding operation.

35. The method of claim 28, further comprising accepting at least one alias name for any one of the item names.
